(19) United States
(12) Patent Application Publication
(10) Pub. No.: US 2018/0083810 A1
(43) Pub. Date: Mar. 22, 2018

(54) Data Loss Prevention from Link Quality Fade

(71) Applicant: Planet Labs, Inc., San Francisco, CA (US)

(72) Inventors: Eric Michael Wun, Burlingame, CA (US); Craig RayDean Scheffler, Lafayette, CO (US)

(21) Appl. No.: 15/267,780

(22) Filed: Sep. 16, 2016

(51) Int. Cl. H04L 27/00; H04B 1/10; H04W 74/04

(52) U.S. Cl. CPC H04L 27/0008; H04W 84/06; H04W 74/04; H04B 1/1027

(57) ABSTRACT

Systems and methods of link fade compensation are provided. For instance, transmission data can be received from a transmitting device. The transmission data can be provided using a first modulation and coding mode. A signal quality value associated with the received transmission data can be determined. Data indicative of a modulation and coding scheme correlating signal quality values to modulation and coding modes can be accessed. A cease data transmission control command can be provided to the transmitting device when the determined signal quality value is less than a cutoff threshold specified by the modulation and coding scheme. The cease data transmission control command includes an instruction to cease transmitting the transmission data.

### FIELD

The present disclosure relates generally mitigating or avoiding data loss associated with radio frequency interference and/or link fade conditions associated with data transmissions.

### BACKGROUND

Satellite systems operating in orbit may be configured to communicate with one or more space-based or ground-based assets using radio frequency transmission signals. For instance, satellite systems may be configured to communicate with other orbital satellite systems and/or one or more ground-based communication stations. As the number of satellite systems in orbit increases, it can become increasingly possible to “mix the data” between such communications. For instance, transmission signals associated with a first satellite system may experience radio frequency interference (RFI) caused by transmission signals associated with a proximate satellite system. Such interference may cause link quality fade associated with the transmission signals. In addition, link fade associated with data transmission to ground-based communication stations can be caused by atmospheric conditions such as rain, snow, and/or ice (e.g. rain fade).

Historically, there has been little need for satellites in non-geosynchronous orbit to avoid radio frequency interference (RFI) due at least in part to the small numbers of such satellites. Recent increases and future expected increases in the number of such satellites have increased the potential for encountering RFI and the need to mitigate or avoid RFI. Current techniques for reducing or avoiding RFI include coordinating transmission times between satellites. However, coordination agreements established using current radio licensing regulations can be inefficient.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of link face compensation, the method includes receiving, by one or more computing devices, transmission data from a transmitting device. The transmission data is provided using a first modulation and coding mode. The method further includes determining, by the one or more computing devices, a signal quality value associated with the received transmission data. The method further includes accessing, by the one or more computing devices, data indicative of a modulation and coding scheme correlating signal quality values to modulation and coding modes. The method further includes providing, by the one or more computing devices, a cease data transmission control command to the transmitting device when the determined signal quality value is less than a cutoff threshold specified by the modulation and coding scheme. The cease data transmission control command includes an instruction to cease transmitting the transmission data.

Other example aspects of the present disclosure are directed to systems, apparatus, tangible, non-transitory computer-readable media, user interfaces, memory devices, and electronic devices for link fade compensation.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example system for reducing radio frequency interference according to example embodiments of the present disclosure;

FIGS. 2-3 depict flow diagrams of example methods of reducing radio frequency interference according to example embodiments of the present disclosure;

FIG. 4 depicts a flow diagram of an example method of determining one or more control commands to be provided to a transmitting device according to example embodiments of the present disclosure;

FIG. 5 depicts a flow diagram of an example method of transmitting transmission data according to example embodiments of the present disclosure; and

FIG. 6 depicts an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to reducing radio frequency interference associated with a transmission of data from a transmitting device to a receiving device. In some implementations, the transmitting device can be a non-geostationary satellite, such as a non-geostationary Earth exploration satellite. When transmitting data to a ground station or other receiving station, such transmitted data can encounter link quality fade issues associated with radio frequency interference (RFI), for instance, caused by data transmissions in the same or similar frequency from nearby satellites and/or other RFI sources. In addition, the transmitted data can encounter link fade issues such as rain fade or other signal obstructions. Such fade issues can degrade the transmitted data and/or can increase an error rate to the total loss of the data. In such instances, the duration of the interference (e.g. caused by link fade and/or link quality fade) can generally last from a few seconds to several minutes. In addition, the start of the interference can be slow enough to detect, for instance, as two or more satellites converge. In this manner, a decline in signal quality caused by the RFI can be detected, and compensated for through use of adaptive coding and modulation techniques that allow for variation in modulation and coding modes used to transmit the data based at least in part on the detected signal quality associated with the transmitted data. However, conventional adaptive coding and modulation techniques do not account for data loss in the case of severe signal degradation caused by RFI.

In this manner, according to example aspects of the present disclosure, transmission data can be received from a transmitting device. The transmission data can be provided using a first modulation and coding mode. A signal quality value associated with the received transmission data can be determined. A modulation and coding scheme correlating signal quality values with modulation and coding modes can be accessed. The signal quality value can be compared against the modulation and coding scheme to determine a second modulation and coding mode with which the transmission data is to be provided. The modulation and coding scheme can further specify a cutoff threshold. When the signal quality value is less than the cutoff threshold, a cease data transmission control command can be provided to the transmitting device. The cease data transmission control command can include an instruction to cease transmitting the transmission data.

More particularly, the transmitting device can be any suitable transmitting device configured to transmit data to a receiving device or station during one or more scheduled transmission periods. For instance, the transmitting device can be a satellite or other aerial system. In some implementations, the transmitting device can be an imaging satellite configured to collect imagery data and to transmit transmission data (e.g. the imagery data) to the receiving station during one or more scheduled transmission periods. The transmission periods can be predetermined based at least in part on a relative location and/or an expected relative location of the transmitting device and/or the receiving station. For instance, a transmission period can be scheduled for a time period during which the transmitting device is expected to be in sight of the receiving station.

The modulation and coding mode can specify a modulation type and a coding rate of a data link (e.g. transmission of data between a transmitting device and a receiving device). The modulation type can be any suitable modulation type. For instance, the modulation type can be a digital modulation type such as amplitude-shift keying (ASK), phase-shift keying (PSK) (e.g. quadrature phase-shift keying (QSPK)), amplitude and phase-shift keying (ASPK) or other suitable modulation type. As will be understood by those skilled in the art, the coding rate can specify a proportion of the transmission that is useful (e.g. non-redundant). In this manner, the coding rate can be any suitable coding rate. In some implementations, the modulation and coding modes can be at least a subset of the modulation and coding modes specified in the Digital Video Broadcasting-Satellite-Second Generation (DVB-S2) broadcast standard, which is defined by the European Telecommunications Standards Institute (ETSI) EN 302 307 v. 1.2.1 standard.

As indicated, one or more signal quality values associated with the data link can be determined during a transmission period. For instance, the signal quality value can be a signal-to-noise ratio (SNR) associated with the transmission data as received by the receiving station. In this manner, the receiving station can determine the SNR associated with the transmission data using one or more suitable SNR determination techniques. In some implementations, the SNR associated with the transmission data can be monitored to detect changes in the SNR during a transmission period. In this manner, multiple SNRs may be determined during a transmission period.

The determined signal quality value can be compared against the modulation and coding scheme to determine a modulation and coding mode with which the transmission is to be sent. As indicated, the modulation and coding scheme can correlate signal quality values with modulation and coding modes. In some implementations, the modulation and coding scheme can correlate a modulation and coding mode with a range of signal quality values. In this manner, when a determined signal quality value associated with the transmission data falls within a range of signal quality values corresponding to a particular modulation and coding mode, a control command can be provided to the transmitting device instructing the transmitting device to provide the transmission data to the receiving station using the corresponding modulation and coding mode.

The modulation and coding scheme can further specify a cutoff threshold. The cutoff threshold can indicate an unacceptable signal quality associated with the received transmission data. In this manner, the cutoff threshold can be determined based at least in part on the nature of the received transmission data and/or an application associated with the transmission data. For instance, in implementations wherein the transmission data is imagery data collected by the transmitting device, the cutoff threshold can be determined based at least in part on a desired image quality of the imagery data as received by the receiving station. When the determined signal quality threshold is less than the cutoff threshold, a cease data transmission control command can be provided to the transmitting device instructing the transmitting device to cease transmitting the transmission data. In this manner, the cease data transmission control command can cause an interruption of the transmission of the transmission data by the transmitting device during a transmission period.

In this manner, provision of the cease data transmission control command to the transmitting device can initiate an interruption period during which the transmitting device does not transmit the transmission data. The interruption period can last until the transmitting device receives a resume data transmission control command. For instance, when the signal quality value exceeds the cutoff threshold during an interruption period (e.g. after having fallen below the cutoff threshold), the receiving station can provide a resume transmission control command to the transmitting device instructing the transmitting device to resume transmission of the transmission data. In this manner, reception of the resume data transmission control command by the transmitting device can signify the end of the interruption period.

In some instances, an interruption period can end during a scheduled transmission period. In such instances, the transmitting device can resume transmitting transmission data during the scheduled transmission period. In some instances, an interruption period can end subsequent to the corresponding transmission period. In such instances, the transmitting device can resume transmission of the transmission data during a subsequently scheduled transmission period.

In some implementations, during an interruption period, the transmitting device can transmit interim data to the receiving station. The interim data can be different data than the transmission data. For instance, the interim data can be null data, pseudo-random data, or other data. The interim data can be transmitted using any suitable modulation and coding mode. For instance, the interim data can be transmitted using the last modulation and coding mode used by the transmitting device prior to the reception of the cease data transmission control command. Transmission of the interim data to the receiving station can allow the receiving station to continue to monitor the signal quality associated with the received interim data during the interruption period. In this manner, when the signal quality value rises above the cutoff threshold during the interruption period, a resume data transmission control command can be provided to the transmitting device instructing the transmitting device to resume transmission of the transmission data.

Compensating for signal quality degradation in real-time according to example embodiments of the present disclosure can allow for improved efficiency in transmitting data from the transmitting device to the receiving station. For instance, such signal quality degradation reduction techniques can eliminate the need to predetermine and/or precoordinate expected RFI periods, and to plan data transmission periods around the expected RFI periods. In addition, such signal quality degradation reduction techniques can increase an amount of transmitted data during the transmission periods in which fade conditions occur. For instance, adjusting the modulation and coding modes with which the transmitted data is sent to compensate for a declining signal quality can allow data to be sent to the receiving station until a point in time when the signal quality becomes unacceptable (e.g. when the signal quality value reaches the cutoff threshold). Ceasing transmission of data when the signal quality becomes unacceptable can allow for an avoidance of data loss. Such avoidance of data loss can eliminate or reduce the need to detect data loss and reschedule the transmission of the lost data.

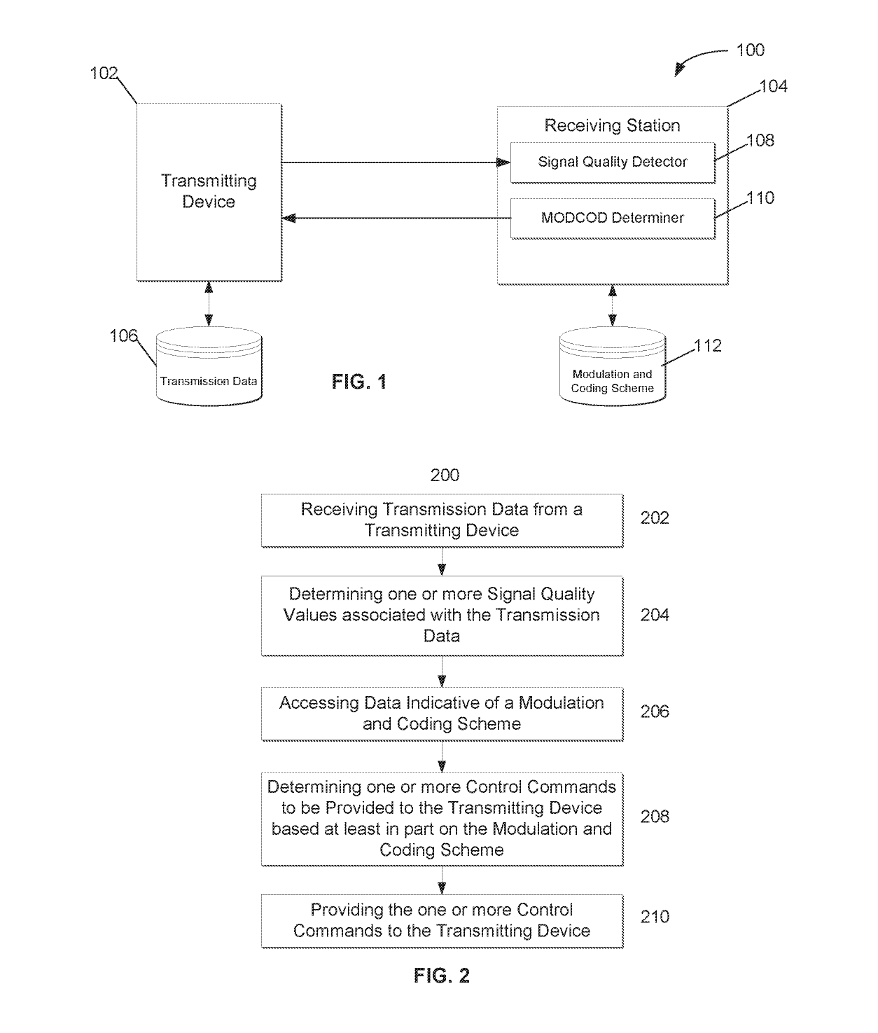

With reference now to the figures, example aspects of the present disclosure will be discussed in greater detail. For instance, FIG. 1 depicts an overview of an example system 100 of reducing RFI according to example embodiments of the present disclosure. System 100 includes a transmitting device 102 and a receiving station 104. Transmitting device 102 can be any suitable device or system capable of transmitting (e.g. wirelessly transmitting) transmission data 106 to receiving station 104. For instance, transmitting device 102 can be a satellite (e.g. non-geostationary imaging satellite, or other satellite), or other suitable transmitting device. In some implementations, transmission data 106 can be data collected or otherwise obtained by transmitting device 102. Transmission data 106 can be stored, for instance, in one or more memory devices implemented within transmitting device 102. For instance, transmission data 106 can be imagery data obtained by one or more image capture devices located on transmitting device 102.

Transmitting device 102 can be configured to transmit the transmission data 106 using one of a plurality of modulation and coding modes. As indicated, a modulation and coding mode can specify a modulation type with which the transmission data 106 is to be sent and a code rate or forward error correction code with which the transmission data 106 is to be sent. As will be discussed in greater detail below, the modulation and coding mode used to transmit the data can be determined by receiving station 104.

Receiving station 104 can include a signal quality detector 108 and a modulation and coding mode (MODCOD) determiner 110. Signal quality detector 108 can be configured to monitor a signal quality of the transmission data 106 as received by receiving station 104. As indicated, the signal quality can be represented as an SNR of the received transmission data 106. In this manner, the SNR can be determined by the signal quality detector 108 using various suitable SNR determination techniques. In some implementations, the signal quality detector 108 can determine one or more signal quality values (e.g. SNR values) associated with the received transmission data 106. For instance, the signal quality detector 108 can determine SNR values of the received transmission data 106 on a periodic or other basis. In some implementations, the signal quality detector 108 can determine the one or more signal quality values in response to receiving the transmission data 106. In some implementations, the signal quality detector 108 can determine the one or more SNR values during a scheduled transmission period during which the transmitting device 102 is scheduled to provide data to the receiving station 104.

The MODCOD determiner 110 can determine a modulation and coding mode to be implemented by the transmitting device 102 in the transmission of the transmission data 106 based at least in part on the determined signal quality value(s). In particular, the MODCOD determiner 110 can access modulation and coding scheme data 112 to determine the modulation and coding mode. The modulation and coding scheme data 112 can correlate signal quality values to modulation and coding modes. For instance, the modulation and coding scheme data 112 can specify a plurality of signal quality value ranges respectively mapped to a plurality of modulation and coding modes. In some implementations, the modulation and coding scheme data 112 can specify signal quality thresholds correlated to the plurality of modulation and coding modes.

The modulation and coding scheme data 112 can be implemented at least in part using adaptive coding and modulation techniques. For instance, the correlation of the modulation and coding modes to signal quality can be determined based at least in part on a tolerance of the modulation and coding modes to interference. In some implementations, the correlation can be determined based at least in part on a path loss associated with the transmission data, a sensitivity of the receiving station 104, an available power associated with the transmitting device 102, or other factor. In this manner, the correlation can be determined to adapt for varying link conditions associated with the transmission of transmission data 106.

Upon a determination of a modulation and coding mode to be used by the transmitting device 102 (e.g. based at least in part on the modulation and coding scheme data 112), the MODCOD determiner 110 can provide a MODCOD control command to the transmitting device 102. The MODCOD control command can include instructions to transmit the transmission data 106 using the determined modulation and coding mode. As an example, upon determination of a signal quality value by the signal quality detector 108, the MODCOD determiner can access the modulation and coding scheme data 112 to determine a modulation and coding mode corresponding to the determined signal quality value. The receiving station 104 can then provide a MODCOD control command to the transmitting device 102 instructing the transmitting device 102 to transmit the transmission data 106 using the determined modulation and coding mode.

As indicated, the modulation and coding scheme data 112 can specify a cutoff threshold. Signal quality values less than the cutoff threshold can be correlated to a cease data transmission control command. In this manner, upon determination of a signal quality value below the cutoff threshold, the receiving station 104 can provide a cease data transmission control command to the transmitting device 102. The cease data transmission control command can include instructions to cease transmitting the transmission data 106. In this manner, in response to receiving the cease data transmission control command, the transmitting device 102 can suspend transmission of the transmission data 106.

Upon reception of a cease data transmission control command by the transmitting device 102 (e.g. during a transmission period), the transmitting device can initiate an interruption period, wherein the transmitting device replaces the transmission data 106 with interim data. In some implementations, the receiving station 104 can instruct the transmitting device 102 to replace the transmission data 106 with the interim data. In some implementations, the transmitting device can be configured to replace the transmission data 106 with the interim data in response to receiving the cease data transmission control command. The interim data can include any suitable data that is different than the transmission data 106. For instance, the interim data can include null data, pseudo-random data, etc. The interim data can be provided to allow the receiving station to receive the interim data and monitor signal quality associated with the received data. In this manner, the receiving station 104 can continue monitoring the signal quality during an interruption period when the transmission data 106 is not being transmitted. As indicated, the interruption period can begin in response to a determination of signal quality below the cutoff threshold. When the signal quality rises above the cutoff threshold during an interruption period, the receiving station 104 can provide a resume data transmission control command to the transmitting device 102. In response to receipt of the resume data transmission control command, the transmitting device 102 can end the interruption period, and resume transmitting the transmission data 106.

As indicated, in some implementations, the transmitting device 102 can be configured to provide the transmission data 106 to the receiving station 104 during one or more predetermined transmission periods. A transmission period may be determined to coincide with a time period wherein the receiving station 104 is “visible” to the transmitting device 102. In some implementations, the data indicative of the transmission periods can be communicated to the transmitting device 102 by the receiving station 104. In this manner, the transmitting device 102 can initiate transmission of the transmission data 106 in accordance with the data indicative of the transmission periods.

In some implementations, the transmission data 106 can be data scheduled to be provided to the receiving station 102 during a particular transmission period. The transmission period can be interrupted when the transmitting device 102 suspends transmission of the transmission data 106 in response to receipt of a cease data transmission control command. In this manner, the interruption period can be a subset of the transmission period. As indicated above, after the interruption period, at least a portion of the remaining transmission data 106 can be provided to the receiving station 104 during the remainder of the scheduled transmission period. If the transmission period ends prior to the transmission of the entirety of the transmission data 106, and/or if the interruption period continues until the end of the transmission period, transmission of the remaining transmission data 106 can be delayed to one or more subsequent transmission periods.

In some implementations, the determination of the modulation and coding mode to use and/or the determination to suspend transmission of the transmission data 106 can be performed by the transmitting device 102. For instance, in such implementations, the signal quality value determined by the receiving station 104 can be communicated to the transmitting device 102. The transmitting device 102 can be configured to access the modulation and coding scheme data 112 to determine the modulation and coding scheme to use to transmit the transmission data 106.

In some implementations, the MODCOD determiner 110 and/or the modulation and coding scheme data 112 can be implemented in the transmitting device 102. In such implementations, the signal quality detector 108 can provide data indicative of the signal quality of data provided by the transmitting device 102 to the MODCOD determiner 110 as implemented in the transmitting device 102. The MODCOD determiner 110 can then access the modulation and coding scheme data 112 and determine a modulation and coding scheme and/or control command (e.g. cease data transmission control command, resume data transmission control command, etc.) according to example embodiments of the present disclosure. In some implementations, the MODCOD determiner 110 and/or modulation and coding scheme data 112 can be implemented within a system or subsystem that is separate and distinct from both the receiving station 104 and the transmitting device 102. In such implementations, the receiving station 104 can provide data indicative of the signal quality of data provided by the transmitting device 102 to the MODCOD determiner 110, as implemented in the separate and distinct system or subsystem. The MODCOD determiner 110 can access the modulation and coding scheme data 112, and determine a modulation and coding scheme and/or control command (e.g. cease data transmission control command, resume data transmission control command, etc.) according to example embodiments of the present disclosure. The MODCOD determiner 110 can then provide data indicative of the determined modulation and coding scheme and/or control command to the transmitting device 102.

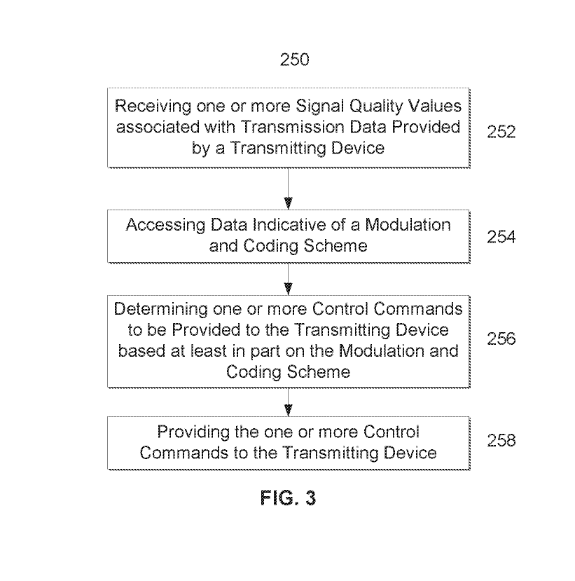

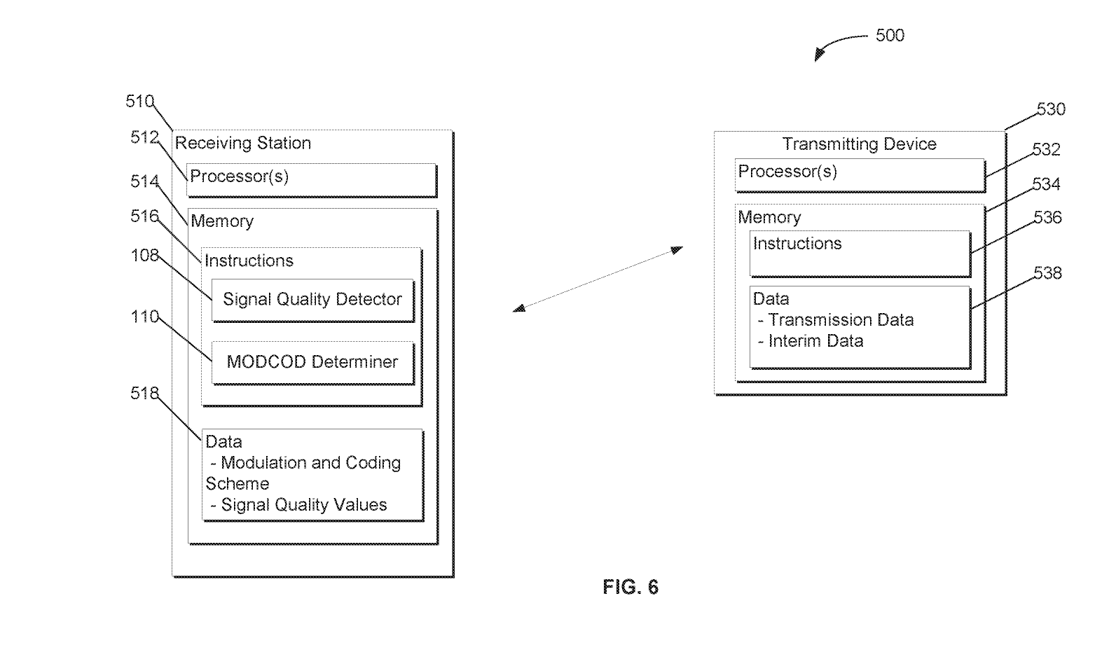

FIG. 2 depicts a flow diagram of an example method (200) of preventing or reducing data loss associated with a transmission of data according to example embodiments of the present disclosure. Method (200) can be implemented by one or more computing devices, such as one or more of the computing devices depicted in FIG. 6. In particular implementations, the method (200) can be implemented by the signal quality detector 108 and the MODCOD determiner 110 depicted in FIG. 1. In addition, FIG. 2 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), method (200) can include receiving transmission data from a transmitting device. The transmission data can be any suitable data communicated (e.g. using wireless transmission techniques) by a transmitting device to a receiving device or station. For instance, the transmission data can be data collected or obtained by the transmitting device and provided to the receiving station during one or more scheduled transmission periods.

At (204), method (200) can include determining one or more signal quality values associated with the received transmission data. For instance, the receiving station can monitor the signal quality of the received data by determining signal quality values associated with the received data on a periodic or other basis. In some implementations, the signal quality values can be SNR values. It will be appreciated that various other signal quality metrics can be determined.

At (206), method (200) can include accessing data indicative of a modulation and coding scheme. The modulation and coding scheme can map or correlate signal quality values to modulation and coding modes. Each modulation and coding mode can specify a The modulation and coding scheme can be determined at least in part using adaptive coding and modulation techniques. In this manner, the correlation of signal quality and modulation and coding modes can be determined based at least in part on a tolerance of the modulation and coding modes to the corresponding SNR values. The modulation and coding scheme can further specify a cutoff threshold defining a minimum signal quality value acceptable for data transmission. In this manner, the cutoff threshold can be correlated to a cease data transmission control command to be provided to the transmitting device. The cease data transmission control command can include one or more instructions to cease transmission of the transmission data. The data indicative of the modulation and coding scheme can be represented as a lookup table or other data structure defining the modulation and coding scheme.

At (208), method (200) can include determining one or more control commands to be provided to the transmitting device based at least in part on the modulation and coding scheme. For instance, determining the one or more control commands can include comparing the determined signal quality value(s) against the modulation and coding scheme to determine a modulation and coding mode to be used by the transmitting device to communicate the transmission data. In this manner, determining one or more control commands can include determining a modulation and coding mode corresponding to a determined signal quality value. In some implementations, the modulation and coding mode can be encoded in a MODCOD control command to be provided to the transmitting device.

In some implementations, determining the one or more control commands can include determining if the signal quality value is less than the cutoff threshold. If the signal quality value is less than the cutoff threshold, the one or more control commands can include a cease data transmission control command to be provided to the transmitting device. Subsequent to a provision of a cease data transmission control command to the transmitting device (e.g. and during an interruption period wherein the transmitting device suspends transmission of the transmission data), determining one or more control commands can include determining if the signal quality has risen back above the cutoff threshold. In this manner, when the signal quality rises back above the cutoff threshold, the one or more control commands can include a resume data transmission control command. In such instance, the one or more control commands can further include a MODCOD control commands specifying a modulation and coding mode to be used to transmit the transmission data. In some implementations, resume transmission instruction and the modulation and coding mode can be included in a single control command.

In some implementations, the determination of the control command(s) to provide to the can be made in response to each signal quality value determination. For instance, upon a determination of each signal quality value, the signal quality value can be compared against the modulation and coding scheme to determine if a new modulation and coding mode is to be used and/or if a cease data transmission control command is to be provided to the transmitting device. If a new modulation and coding mode is to be used and/or if a cease data transmission control command is to be provided, one or more suitable control commands can be generated. In some implementations, the determination of the control command(s) can occur responsive to a detection of a change in the signal quality associated with the received data. For instance, a determined signal quality value can be compared against the most recently determined signal quality value to determine if a change in signal quality has occurred. If a change has occurred, the current signal quality value can be compared against the modulation and coding scheme to determine whether a MODCOD, cease transmission, and/or resume data transmission control command is to be provided to the transmitting device. In some implementations, a control command will be generated and provided to the transmitting device only to facilitate an operation change of the transmitting device. For instance, the control commands can be associated with a change in the modulation and coding mode to be used, a suspension of the transmission of transmission data during a transmission period, and/or a resuming of the transmission of transmission data during an interruption period.

At (210), method (200) can include providing data indicative of the one or more control commands to the transmitting device. For instance, the receiving station (or other suitable entity) can transmit the one or more control commands to the transmitting device to facilitate a performance of an operation of the transmitting device.

As indicated, in some implementations, the control commands (e.g. MODCOD control commands, resume data transmission control commands, and/or resume data transmission control commands) can be determined by a separate and distinct device from the receiving station. For instance, FIG. 3 depicts a flow diagram of an example method (250) of preventing or reducing data loss according to example embodiments of the present disclosure. Method (250) can be implemented by one or more computing devices, such as one or more of the computing devices depicted in FIG. 6. In particular implementations, the method (250) can be implemented by the MODCOD determiner 110 depicted in FIG. 1. In this manner, the method (250) can be implemented by the MODCOD determiner 110 in implementations wherein the MODCOD determiner 110 is implemented in a separate and distinct device from the receiving station 104 of FIG. 1.

At (252), method (250) can include receiving one or more signal quality values associated with transmission data provided by a transmitting device. For instance, the signal quality values can be determined by a signal quality detector associated with a receiving station configured to receive transmission data provided by the transmitting device. The receiving station and/or signal quality determiner can then provide the signal quality values to one or more devices configured to determine control commands to be provided to the transmitting device. At (254), method (250) can include accessing data indicative of a modulation and coding scheme according to example embodiments of the present disclosure.

At (256), method (250) can include determining one or more control commands to be provided to the transmitting device based at least in part on the modulation and coding scheme. As indicated above, in some implementations, the one or more control commands can be determined by a system or subsystem implemented within the transmitting device. In some implementations, the one or more control commands can be determined by a system or subsystem associated with a separate and distinct device from the transmitting device. At (258), method (250) can include providing the one or more control commands to the transmitting device. In implementations wherein the control commands are determined by a system or subsystem implemented within the transmitting device, the control commands can be provided to a system or subsystem within the transmitting device configured to implement the control commands and/or transmit data according to the determined control commands.

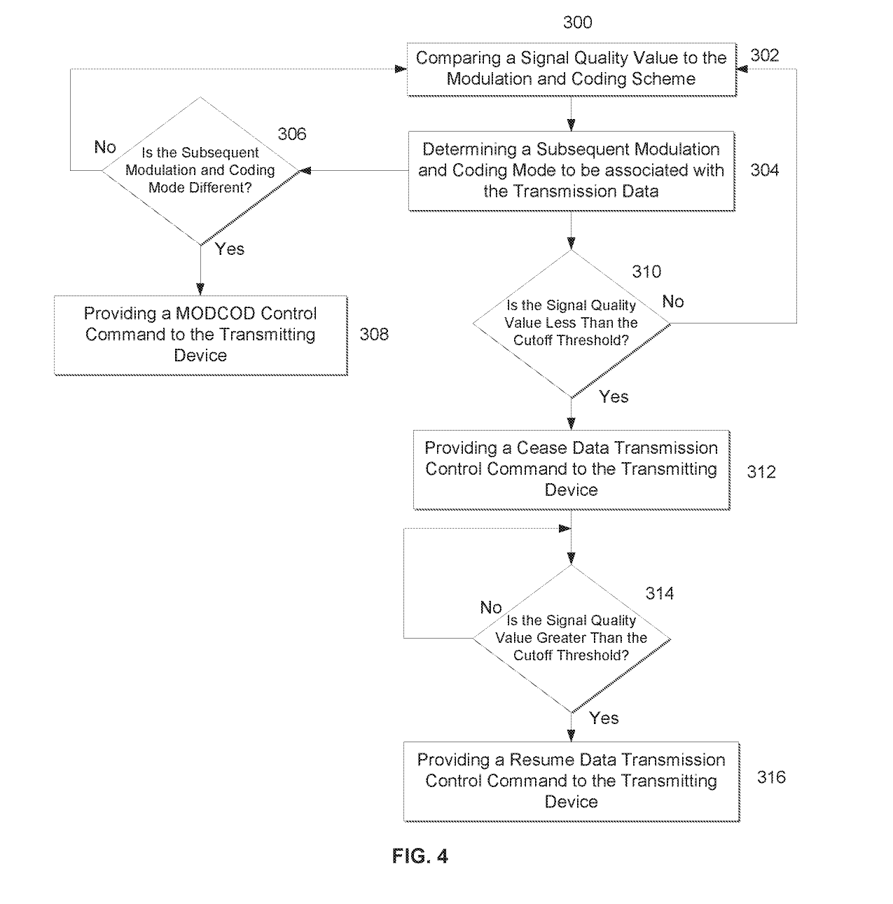

FIG. 4 depicts a flow diagram of an example method (300) of providing control commands to the transmitting device according to example embodiments of the present disclosure. Method (300) can be implemented by one or more computing devices, such as one or more of the computing devices depicted in FIG. 6. In particular implementations, the method (300) can be implemented by the signal quality detector 108 and the MODCOD determiner 110 depicted in FIG. 1.

At (302), method (300) can include comparing a signal quality value to a modulation and coding scheme. As indicated, the signal quality value can be compared against the modulation and coding scheme to determine a modulation and coding mode corresponding to the determined signal quality value.

At (304), method (300) can include determining a subsequent modulation and coding mode to be associated with the transmission data based at least in part on the comparison. At (306), method (300) can include determining if the subsequent modulation and coding mode is different than the current modulation and coding mode. If the subsequent mode is different, at (308), method (300) can include providing a MODCOD control command to the transmitting device. The MODCOD control command can encode the subsequent modulation and coding mode and can include one or more instructions to implement the subsequent modulation and coding mode. If, at (306), the subsequent mode is not different that the current mode, method (300) can return to (302).

At (310), method (300) can include determining if the signal quality value is less than the cutoff threshold specified by the modulation and coding scheme. If the signal quality value is less than the cutoff threshold, method (300) can include providing a cease data transmission control command to the transmitting device (312). The cease data transmission control command can include instructions to suspend transmission of the transmission data. In some implementations, the cease data transmission control command can include further instructions to initiate a transmission of suitable interim data to replace the transmission data. In some implementations, the transmitting device can automatically begin transmitting the interim data to replace the transmission data. For instance, the transmitting device can include an automatic regression to interim data if there is not transmission data at the input of the transmitting device. In such implementations, a specific control command instructing the transmitting device to transmit interim data may not be necessary. If, at (310), the signal quality value is not less than the cutoff threshold, method (300) can include returning to (302).

At (314), method (300) can include determining whether the signal quality value is greater than the cutoff threshold. For instance, once the signal quality value falls below the cutoff threshold, and a cease data transmission control command is provided to the transmitting device, the signal quality can be monitored to determine if the signal quality rises back above the cutoff threshold. If the signal quality value is greater than the cutoff threshold, method (300) can include providing a resume data transmission control command to the transmitting device (316). The resume data transmission control command can include instructions to resume transmission of the transmission data. If, at (314), the signal quality value is not greater than the cutoff threshold, method (300) can include continuing to monitor the signal quality value.

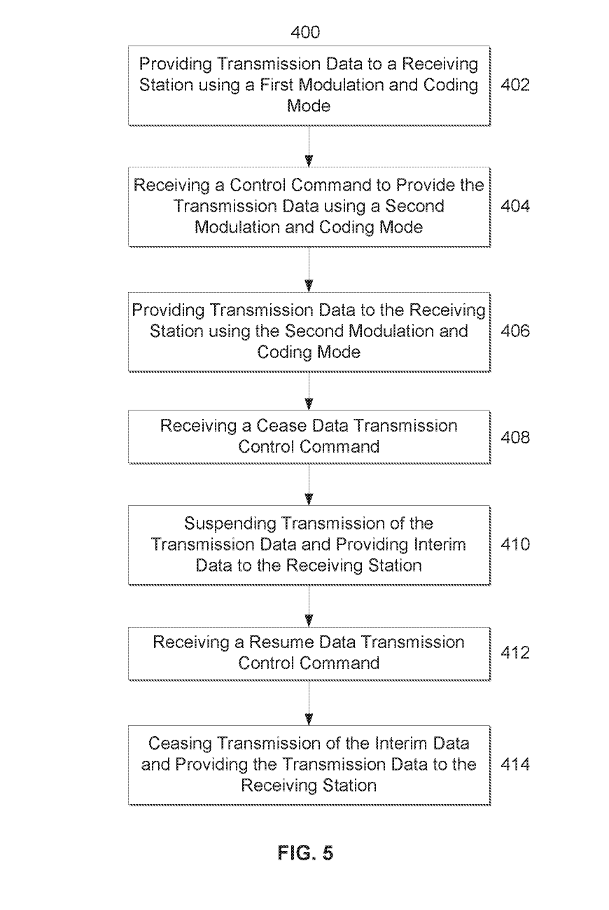

FIG. 5 depicts a flow diagram of an example method (400) of providing data to a receiving station according to example embodiments of the present disclosure. Method (400) can be implemented by one or more computing devices, such as one or more of the computing devices depicted in FIG. 6. In particular implementations, the method (200) can be implemented by the transmitting device 102 depicted in FIG. 1.

At (402), method (400) can include providing transmission data to a receiving station using a first modulation and coding mode. As indicated, the first modulation and coding mode can include a first modulation type and code rate used to transmit the transmission data. At (404), method (400) can include receiving a MODCOD control command to provide the transmission data using a second modulation and coding mode. In some implementations, the MODCOD control command can be provided by the receiving station. At (406), method (400) can include providing the transmission data to the receiving station using the second modulation and coding mode in accordance with the MODCOD control command.

At (408), method (400) can include receiving a cease data transmission control command. The cease data transmission control command can be provided in response to a detection of the signal quality associated with the reception of the transmission data by the receiving station falling below a cutoff threshold. The cease data transmission control command can include instructions to suspend transmission of the transmission data. In some implementations, the cease data transmission control command can include instructions to suspend the transmission of the transmission data until a resume data transmission control command is received. In some implementations, the cease data transmission control command can include instructions to replace the transmission data with suitable interim data. In some implementations, the transmitting device may automatically replace the transmission data with interim data, for instance, through an automatic regression technique.

At (410), method (400) can include suspending transmission of the transmission data and providing the interim data to the receiving station in accordance with the cease data transmission control command. At (412), method (400) can include receiving a resume data transmission control command. The resume data transmission control command can include instructions to resume transmitting the transmission data and/or to cease transmission of the interim data. The resume data transmission control command can be provided in response to a detection of the signal quality of the interim data rising above the cutoff threshold. At (414), method (400) can include ceasing transmission of the interim data and resuming transmission of the transmission data to the receiving station in accordance with the resume data transmission control command.

FIG. 6 depicts an example computing system 500 that can be used to implement the methods and systems according to example aspects of the present disclosure. The system 500 can be implemented using a receiving station 510 that communicates with one or more transmitting devices 530.

The system 500 includes a receiving station 510. The receiving station 510 can be any suitable device or station capable of receiving data from the transmitting device(s) 530. In this manner, the receiving station 510 may include one or more transmitters, receivers, ports, controllers, antennas, or other suitable components used to communicate with the transmitting device(s) 530. The receiving station 510 can be implemented using any suitable computing device(s). The receiving station 510 can have one or more processors 512 and one or more memory devices 514. The receiving station 510 can also include a network interface used to communicate with one or more remote devices, for instance, over a network. The network interface can include any suitable components for interfacing with one more networks, including for example, transmitters, receivers, ports, controllers, antennas, or other suitable components.

The one or more processors 512 can include any suitable processing device, such as a microprocessor, microcontroller, integrated circuit, logic device, or other suitable processing device. The one or more memory devices 514 can include one or more computer-readable media, including, but not limited to, non-transitory computer-readable media, RAM, ROM, hard drives, flash drives, or other memory devices. The one or more memory devices 514 can store information accessible by the one or more processors 512, including computer-readable instructions 516 that can be executed by the one or more processors 512. The instructions 516 can be any set of instructions that when executed by the one or more processors 512, cause the one or more processors 512 to perform operations. For instance, the instructions 516 can be executed by the one or more processors 512 to implement a signal quality detector 108 and a MODCOD determiner 110 described with reference to FIG. 1. As indicated above, although the MODCOD determiner 110 and modulation and coding scheme data are depicted as being implemented within the receiving station 510, it will be appreciated by those skilled in the art that the MODCOD determiner 110 and/or the modulation and coding scheme data can be implemented in one or more alternative systems. For instance, the MODCOD determiner 110 and/or the modulation and coding scheme data can be implemented within the transmitting device 530 or within a separate and distinct system from the receiving station 510 and the transmitting device 530.

As shown in FIG. 6, the one or more memory devices 514 can also store data 518 that can be retrieved, manipulated, created, or stored by the one or more processors 512. The data 518 can include, for instance, modulation and coding scheme data, signal quality values determined according to example embodiments of the present disclosure, and other data. The data 518 can be stored in one or more databases. The one or more databases can be implemented within the receiving station 510, or can be connected to the receiving station 510 by a high bandwidth LAN or WAN, or can also be connected to receiving station 510 through network 540. The one or more databases can be split up so that they are located in multiple locales.

The receiving station 510 can exchange data with one or more transmitting devices 530. Although two transmitting devices 530 are illustrated in FIG. 6, any number of transmitting devices 530 can be connected to the receiving station 510 over the network 540. Each of the transmitting devices 530 can be any suitable type of computing device capable of transmitting data to the receiving station 510. In this manner the transmitting devices 530 may include one or more transmitters, receivers, ports, controllers, antennas, or other suitable components used to communicate with the receiving station 510. In some implementations, a transmitting device 530 can be a satellite, such as an imaging satellite in non-geosynchronous orbit.

Similar to the receiving station 510, a transmitting device 530 can include one or more processor(s) 532 and a memory 534. The one or more processor(s) 532 can include one or more central processing units (CPUs), graphics processing units (GPUs) dedicated to efficiently rendering images or performing other specialized calculations, and/or other processing devices. The memory 534 can include one or more computer-readable media and can store information accessible by the one or more processors 532, including instructions 536 that can be executed by the one or more processors 532 and data 538.

The transmitting device 530 can also include a network interface used to communicate with one or more remote computing devices over a network. The network interface can include any suitable components for interfacing with one more networks, including for example, transmitters, receivers, ports, controllers, antennas, or other suitable components.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of preventing data loss, the method comprising:
receiving, by one or more computing devices, transmission data from a transmitting device, the transmission data being provided using a first modulation and coding mode;
determining, by the one or more computing devices, a signal quality value associated with the received transmission data;
accessing, by the one or more computing devices, data indicative of a modulation and coding scheme correlating signal quality values to modulation and coding modes; and
providing, by the one or more computing devices, a cease data transmission control command to the transmitting device when the determined signal quality value is less than a cutoff threshold specified by the modulation and coding scheme, the cease data transmission control command comprising an instruction to cease transmitting the transmission data.

2. The computer-implemented method of claim 1, wherein receiving, by the one or more computing devices, transmission data from a transmitting device comprises receiving the transmission data during a scheduled transmission period.

3. The computer-implemented method of claim 2, wherein providing, by the one or more computing devices, a cease data transmission control command to the transmitting device comprises providing the cease data transmission control command during the scheduled transmission period.

4. The computer-implemented method of claim 1, further comprising determining, by the one or more computing devices, a second modulation and coding mode with which the transmission data is to be provided based at least in part on the signal quality value and the modulation and coding scheme.

5. The computer-implemented method of claim 4, further comprising providing, by the one or more computing devices, a control command to the transmitting device instructing the transmitting device to transmit the transmission data using the second modulation and coding mode.

6. The computer-implemented method of claim 1, further comprising providing, by the one or more computing devices, a resume data transmission control command to the transmitting device, the resume data transmission control command comprising an instruction to resume transmission of the transmission data when the signal quality value is greater than the cutoff threshold specified by the modulation and coding scheme.

7. The computer-implemented method of claim 6, wherein providing, by the one or more computing devices, a resume data transmission control command to the transmitting device comprises providing the resume data transmission control command to the transmitting device subsequent to the provision of the cease data transmission control command.

8. The computer-implemented method of claim 1, further comprising:
comparing, by the one or more computing devices, the signal quality value to the cutoff threshold; and
determining, by the one or more computing devices, that the signal quality value is less than the cutoff threshold.

9. The computer-implemented method of claim 1, wherein the signal quality value is a signal-to-noise ratio associated with the received transmission data.

10. The computer-implemented method of claim 1, wherein the cease data transmission control command further comprises an instruction to transmit interim data in place of the transmission data.

11. The computer-implemented method of claim 9, wherein the interim data comprises null data.

12. The computer-implemented method of claim 1, wherein the modulation and coding scheme implements one or more adaptive coding and modulation techniques.

13. A computing system, comprising:
one or more processors; and
one or more memory devices, the one or more memory devices storing computer-readable instructions that when executed by the one or more processors cause the one or more processors to perform operations, the operations comprising:
receiving data indicative of a signal quality value associated with transmission data provided by a transmitting device;
accessing data indicative of a modulation and coding scheme correlating signal quality values to modulation and coding modes; and
providing a cease data transmission control command to the transmitting device when the determined signal quality value is less than a cutoff threshold specified by the modulation and coding scheme, the cease data transmission control command comprising an instruction to suspend transmission of the transmission data.

14. The computing system of claim 13, wherein receiving transmission data from a transmitting device comprises receiving the transmission data during a scheduled transmission period.

15. The computing system of claim 14, wherein providing a cease data transmission control command to the transmitting device comprises providing the cease data transmission control command during the scheduled transmission period.

16. The computing system of claim 13, the operations further comprising determining a second modulation and coding mode with which the transmission data is to be provided based at least in part on the signal quality value and the modulation and coding scheme.

17. One or more tangible, non-transitory computer-readable media storing computer-readable instructions that when executed by one or more processors cause the one or more processors to perform operations, the operations comprising:
receiving transmission data from a transmitting device, the transmission data being provided using a first modulation and coding mode;
determining a signal quality value associated with the received transmission data;
accessing data indicative of a modulation and coding scheme correlating signal quality values to modulation and coding modes; and
providing a cease data transmission control command to the transmitting device in response to the determined signal quality value being less than a cutoff threshold specified by the modulation and coding scheme, the cease data transmission control command comprising an instruction to suspend transmission of the transmission data.

18. The one or more tangible, non-transitory computer-readable media of claim 17, the operations further comprising further comprising determining a second modulation and coding mode with which the transmission data is to be provided based at least in part on the signal quality value and the modulation and coding scheme.

19. The one or more tangible, non-transitory computer-readable media of claim 18, wherein providing a resume data transmission control command to the transmitting device comprises providing the resume data transmission control command to the transmitting device subsequent to the provision of the cease data transmission control command.

20. The one or more tangible, non-transitory computer-readable media of claim 17, wherein the cease data transmission control command further comprises an instruction to transmit interim data in place of the transmission data.
